(19) United States
(12) Patent Application Publication
(10) Pub. No.: US 2023/0412318 A1
(43) Pub. Date: Dec. 21, 2023

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(21) Appl. No.: 18/242,536

(22) Filed: Sep. 6, 2023

Related U.S. Application Data
(63) Continuation of application No. PCT/CN2022/079558, filed on Mar. 7, 2022.

(30) Foreign Application Priority Data
Mar. 12, 2021 (CN) 202110270118.6

(51) Int. Cl. H04L 1/1829; H04L 1/1812

(52) U.S. Cl. CPC H04L 1/1854; H04L 1/1812

(57) ABSTRACT

The present application provides a method and device in a node for wireless communications. A node firstly receives a first information block, the first information block is used to disable K1 HARQ process identities, and the K1 HARQ process identities are a subset of K HARQ process identities; then monitors a first signaling in a first time-frequency resource pool, and receives Q data units according to an indication of the first signaling; and finally transmits a target information block in a first resource set; the first signaling is used to indicate Q HARQ process identities, and the Q data units respectively correspond to the Q HARQ process identities; the target information block comprises M1 bit group(s), the M1 bit group(s) indicates(indicate) whether Q1 data unit(s) in the Q data units is(are) correctly received. The present application optimizes the transmission of uplink feedback to reduce the signaling overhead.

### CROSS REFERENCE TO RELATED APPLICATIONS

This application is the continuation of the international patent application No. PCT/CN2022/079558, filed on Mar. 7, 2022, and claims the priority benefit of Chinese Patent Application No. 202110270118.6, filed on Mar. 12, 2021, the full disclosure of which is incorporated herein by reference.

### BACKGROUND

### Technical Field

The present application relates to transmission methods and devices in wireless communication systems, and in particular to a design scheme and device of uplink feedback in wireless communications.

### Related Art

Hybrid Automatic Repeat reQuest Acknowledgment (HARQ-ACK) in 5G NR standard supports two codebook generation methods, namely type 1 HARQ-ACK codebook and type 2 HARQ-ACK codebook. The generation of type 1 HARQ-ACK codebook does not dynamically change with the actual data scheduling situation, while a size of the type 2 HARQ-ACK codebook dynamically changes with the actual data scheduling situation. Meanwhile, in the issue of “supporting 52.6 GHz to 71 GHz” in NR Rel-17 architecture, a Physical Downlink Control Channel (PDCCH) supports scheduling multiple independent Transport Blocks (TBs) to reduce the overhead of control signaling. At the same time, under NR Rel-17 architecture, in order to save uplink overhead and improve transmission efficiency, the base station can indicate the terminal to disable HARQ-ACK feedback of partial HARQ process identities. When the scheme of disabling HARQ-ACK feedback of partial HARQ process identities mentioned above is applied to scenarios from 52.6 GHz to 71 GHz, the uplink feedback generated based on type 1 HARQ-ACK codebook will need to be redesigned.

### SUMMARY

A simple way to generate a type 1 HARQ-ACK codebook is that a size of the codebook is only related to all HARQ process identities not disabled by the terminal. However, when the terminal supports a large number of HARQ process identities, considering the control signaling overhead and scheduling limitations, the base station may not be able to schedule data transmissions corresponding to all HARQ process identities at once, therefore, the type 1 HARQ-ACK can also be further optimized to save control the signaling overhead.

To address the above problem, the present application provides a solution. It should be noted that although the above description pertains to the scenario of enabled/disabled HARQ feedback, the present application is also applicable to other scenarios such as scenarios of enabling all HARQ process identity feedback, where similar technical effects can be achieved. Additionally, the adoption of a unified solution for various scenarios, including but not limited to scenarios between 52.6 GHz and 71 GHz, contributes to the reduction of hardcore complexity and costs. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In response to the above issues, the present application discloses a method and device for generating HARQ codebooks. It should be noted that the embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict. Though originally targeted at cellular network, the present application is also applicable to Internet of Things (IoT) and Internet of Vehicles (IoV). Though originally targeted at multi-carrier communications, the present application is also applicable to single-carrier communications. Though originally targeted at unicast and groupcast communications, the present application is also applicable to multicast and groupcast communications. Besides, the present application is not only targeted at scenarios of terminals and base stations, but also at communication scenarios between terminals and terminals, terminals and relays, Non-Terrestrial Networks as well as relays and base stations, where similar technical effects can be achieved. Additionally, the adoption of a unified solution for various scenarios, including but not limited to communication scenarios between terminals and base stations, contributes to the reduction of hardware complexity and costs.

Further, embodiments of a first node in the present application and the characteristics of the embodiments may be applied to a second node if no conflict is incurred, and vice versa. Particularly, for interpretations of the terminology, nouns, functions and variants (if not specified) in the present application, refer to definitions given in Technical Specification (TS) 36 series, TS38 series and TS37 series of 3GPP specifications.

The present application provides a method in a first node for wireless communications, comprising:
receiving a first information block, the first information block being used to disable HARQ-ACKs for K1 HARQ process identities, the K1 HARQ process identities being a subset of K HARQ process identities, K1 being a positive integer greater than 1 and K being a positive integer greater than K1;
monitoring a first signaling in a first time-frequency resource pool, the first time-frequency resource pool belonging to a search space set; when the first signaling is detected, receiving Q radio signals according to an indication of the first signaling, the Q radio signals respectively comprising Q data units; and
transmitting a target information block in a first resource set;
herein, the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

In one embodiment, one technical feature of the above method is in: the target information block carries a HARQ-ACK, and the HARQ-ACK carried by the target information block is determined only by a number of enabled HARQ process identities that can be indicated by the first signaling at once instead of by a number of enabled HARQ process identities of the first node; when the first signaling adopts an indication method of time window for scheduling, the above method reduces a number of reserved HARQ-ACK bit(s) in the target information block, so as to reduce the overhead of an uplink signaling.

According to one aspect of the present application, the first signaling comprises a first field, the first field in the first signaling is used to indicate a first time offset, and the first resource set occupies a target time unit; a last data unit in the Q1 data unit(s) occupies a first time unit; the first time unit and the first time offset are used together to determine the target time unit.

In one embodiment, one technical feature of the above method is in: the first resource set corresponds to a Physical Uplink Control Channel (PUCCH) resource, and resources occupied by actually feeding back PUCCH(s) of the Q1 data unit(s) are determined by a last HARQ process identity among the Q1 HARQ process identity(identities).

According to one aspect of the present application, comprising:
receiving a second information block;
herein, the second information block is used to determine a value of the P.

In one embodiment, one technical feature of the above method is in: the base station indicates to the first node a largest number of slot(s) that a DCI can schedule when the DCI is applied to multiple TB schedulings, the number of slot(s) indirectly determines a number of enabled HARQ process identities that can be indicated by the first signaling at once.

According to one aspect of the present application, comprising:
receiving a third information block;
herein, the first resource set occupies a target time unit, the Q1 data unit(s) occupies(respectively occupy) Q1 time unit(s), and the third information block is used to determine that the target time unit is associated with the Q1 time unit(s).

In one embodiment, one technical feature of the above method is in: by indicating a slot set associated with the target time unit through the third information block to determine that a HARQ-ACK feedback of a Physical Downlink Shared Channel (PDSCH) transmitted in the Q1 time unit(s) is transmitted in the target time unit.

According to one aspect of the present application, the Q1 bit group(s) is(are) first Q1 bit group(s) among the M1 bit group(s).

In one embodiment, one technical feature of the above method is in: predefining a position of the Q1 bit group(s) within the M1 bit group(s) to avoid the ambiguity between the base station and the terminal.

According to one aspect of the present application, the first signaling comprises a second field, the second field in the first signaling is used to indicate a first one of HARQ process identities among the Q HARQ process identities.

In one embodiment, one technical feature of the above method is in: when scheduling multiple HARQ process identities, the first signaling adopts the method of indicating a start HARQ process identity combined with indicating a time window to save the signaling overhead while ensuring the flexibility.

According to one aspect of the present application, the target information block adopts a generation method of type 1 HARQ-ACK codebook.

The present application provides a method in a second node for wireless communications, comprising:
transmitting a first information block, the first information block being used to disable HARQ-ACKs for K1 HARQ process identities, the K1 HARQ process identities being a subset of K HARQ process identities, K1 being a positive integer greater than 1 and K being a positive integer greater than K1;
transmitting a first signaling in a first time-frequency resource pool, the first time-frequency resource pool belonging to a search space set; the first signaling indicating a transmission of Q radio signals, the Q radio signals respectively comprising Q data units; and
receiving a target information block in a first resource set;
herein, the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

According to one aspect of the present application, the first signaling comprises a first field, the first field in the first signaling is used to indicate a first time offset, and the first resource set occupies a target time unit; a last data unit in the Q1 data unit(s) occupies a first time unit; the first time unit and the first time offset are used together to determine the target time unit.

According to one aspect of the present application, comprising:
transmitting a second information block;
herein, the second information block is used to determine a value of the P.

According to one aspect of the present application, comprising:
transmitting a third information block;
herein, the first resource set occupies a target time unit, the Q1 data unit(s) occupies(respectively occupy) Q1 time unit(s), and the third information block is used to determine that the target time unit is associated with the Q1 time unit(s).

According to one aspect of the present application, the Q1 bit group(s) is(are) first Q1 bit group(s) among the M1 bit group(s).

According to one aspect of the present application, the first signaling comprises a second field, the second field in the first signaling is used to indicate a first one of HARQ process identities among the Q HARQ process identities.

According to one aspect of the present application, the target information block adopts a generation method of type 1 HARQ-ACK codebook.

The present application provides a first node for wireless communications, comprising:
a first receiver, receiving a first information block, the first information block being used to disable HARQ-ACKs for K1 HARQ process identities, the K1 HARQ process identities being a subset of K HARQ process identities, K1 being a positive integer greater than 1 and K being a positive integer greater than K1;
a second receiver, monitoring a first signaling in a first time-frequency resource pool, the first time-frequency resource pool belonging to a search space set; when the first signaling is detected, receiving Q radio signals according to an indication of the first signaling, the Q radio signals respectively comprising Q data units; and
a first transmitter, transmitting a target information block in a first resource set;
herein, the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

The present application provides a second node for wireless communications, comprising:
a second transmitter, transmitting a first information block, the first information block being used to disable HARQ-ACKs for K1 HARQ process identities, the K1 HARQ process identities being a subset of K HARQ process identities, K1 being a positive integer greater than 1 and K being a positive integer greater than K1;
a third transmitter, transmitting a first signaling in a first time-frequency resource pool, the first time-frequency resource pool belonging to a search space set; the first signaling indicating a transmission of Q radio signals, the Q radio signals respectively comprising Q data units; and
a third receiver, receiving a target information block in a first resource set;
herein, the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

In one embodiment, the present application has the following advantages over conventional schemes:
the target information block carries a HARQ-ACK, and the HARQ-ACK carried by the target information block is determined only by a number of enabled HARQ process identities that can be indicated by the first signaling at once instead of by a number of enabled HARQ process identities of the first node; when the first signaling adopts an indication method of time window for scheduling, the above method reduces a number of reserved HARQ-ACK bit(s) in the target information block and reduces the overhead of uplink signaling;
the base station indicates to the first node a largest number of slot(s) that a DCI can schedule when the DCI is applied to multiple TB schedulings, and the number of slot(s) indirectly determines a number of enabled HARQ process identities that can indicated by the first signaling at once;
predefining a position of the Q1 bit group(s) within the M1 bit group(s) to avoid the ambiguity between the base station and the terminal;
when scheduling multiple HARQ process identities, the first signaling adopts the method of indicating a start HARQ process identity combined with indicating a time window to save the signaling overhead while ensuring flexibility.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of a first information block according to one embodiment of the present application;

FIG. 6 illustrates a schematic diagram of K1 process identities according to one embodiment of the present application;

FIG. 7 illustrates a schematic diagram of Q data units according to one embodiment of the present application;

FIG. 8 illustrates a schematic diagram of M1 bit group(s) according to one embodiment of the present application;

FIG. 9 illustrates a schematic diagram of P HARQ process identities indicated by the first signaling at most according to one embodiment of the present application;

FIG. 10 illustrates a schematic diagram of a first signaling according to one embodiment of the present application;

FIG. 11 illustrates a schematic diagram of a first time unit and a first time offset according to one embodiment of the present application;

FIG. 12 illustrates a schematic diagram of a target time unit according to one embodiment of the present application;

FIG. 13 illustrates a structure block diagram of a processor in a first node according to one embodiment of the present application;

FIG. 14 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a processing flowchart of a first node, as shown in FIG. 1. In step 100 illustrated by FIG. 1, each box represents a step. In Embodiment 1, the first node in the present application receives a first information block in step 101; then monitors a first signaling in a first time-frequency resource pool in step 102, and receives Q radio signal(s) according to an indication of the first signaling; transmits a target information block in a first resource set in step 103.

In embodiment 1, the first information block is used to disable HARQ-ACKs for K1 HARQ process identities, the K1 HARQ process identities are a subset of K HARQ process identities, K1 being a positive integer greater than 1 and K being a positive integer greater than K1; the first time-frequency resource pool belongs to a search space set; the first signaling is detected by the first node; the Q radio signals respectively comprise Q data units; the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

In one embodiment, the first information block is transmitted through a Radio Resource Control (RRC) signaling.

In one embodiment, the first information block is UE-specific.

In one embodiment, the first information block is transmitted through Medium Access Control (MAC) Control Elements (CEs).

In one embodiment, the first information block is dynamically transmitted through a physical-layer signaling.

In one embodiment, the first information block is transmitted through a PDCCH.

In one embodiment, the first information block is a Bitmap.

In one embodiment, the first information block comprises K bits, K being a positive integer greater than 1, and K is equal to a maximum number of HARQ processes supported by the first node.

In one subembodiment of the above embodiment, K is equal to 8.

In one subembodiment of the above embodiment, K is equal to 16.

In one subembodiment of the above embodiment, K is equal to 32

In one subembodiment of the above embodiment, K1 bits out of the K bits are respectively used to indicate K1 disabled HARQ process identities.

In one embodiment, the meaning of the above phrase that HARQ-ACKs for K1 HARQ process identities comprises: the first node will not provide feedback on a corresponding HARQ-ACK for any of the K1 HARQ process identities.

In one embodiment, the meaning of the above phrase that HARQ-ACKs for K1 HARQ process identities comprises: a given data unit adopts one of the K1 HARQ process identities, and the first node provides feedback on a corresponding HARQ-ACK based on whether the given data unit is correctly received after receiving the given data unit.

In one embodiment, the meaning of the above phrase that HARQ-ACKs for K1 HARQ process identities comprises: a given data unit adopts one of the K1 HARQ process identities, the first node does not provide feedback on HARQ-ACK after receiving the given data unit, regardless of whether the given data unit is correctly received.

In one embodiment, the meaning of the above phrase that HARQ-ACKs for K1 HARQ process identities comprises: a given data unit adopts one of the K1 HARQ process identities, the first node provides feedback on NACK after receiving the given data unit, regardless of whether the given data unit is correctly received.

In one embodiment, the meaning of the above phrase that HARQ-ACKs for K1 HARQ process identities comprises: a given data unit adopts one of the K1 HARQ process identities, the first node provides feedback on ACK after receiving the given data unit, regardless of whether the given data unit is correctly received.

In one embodiment, the meaning of the above phrase of disabling HARQ-ACKs for K1 HARQ process identities comprises: the first node assumes that there exists no PUCCH resource reserved for transmitting feedback for any of the K1 HARQ process identities.

In one embodiment, a maximum number of HARQ processes that can be supported by the first node is equal to K.

In one embodiment, a maximum number of HARQ processes that can be supported by the first node on a BWP is equal to K.

In one embodiment, a maximum number of HARQ processes that can be supported by the first node on a carrier is equal to K.

In one embodiment, the meaning of the above phrase that the K1 HARQ process identities are a subset of K HARQ process identities comprises: any HARQ process identity among the K1 HARQ process identities is one of the K HARQ process identities.

In one embodiment, the meaning of the above phrase that the K1 HARQ process identities are a subset of K HARQ process identities comprises: there at least exists one HARQ process identity among the K HARQ process identities being a HARQ process identity other than the K HARQ process identities.

In one embodiment, time-domain resources occupied by the first time-frequency resource pool belong to a Search Space.

In one embodiment, time-domain resources occupied by the first time-frequency resource pool belong to a Search Space Set.

In one embodiment, frequency-domain resources occupied by the first time-frequency resource pool belong to a Control Resource Set (CORESET).

In one embodiment, the first signaling is a piece of Downlink Control Information (DCI).

In one embodiment, the first signaling is a piece of Sidelink Control Information (SCI).

In one embodiment, the first signaling is a DL Grant.

In one embodiment, a physical-layer channel occupied by the first signaling comprises a PDCCH.

In one embodiment, the first signaling is used to determine frequency-domain resources occupied by the Q radio signals.

In one subembodiment of the above embodiment, the first signaling is used to indicate frequency-domain resources respectively occupied by the Q radio signals.

In one subembodiment of the above embodiment, the first signaling is used to indicate frequency-domain resources occupied by an earliest radio signal among the Q radio signal(s) in time domain.

In one embodiment, the first signaling is used to determine Q HARQ process identities respectively occupied by the Q radio signals.

In one embodiment, the first signaling is used to indicate a HARQ process identity occupied by an earliest radio signal among the Q radio signals in time domain.

In one embodiment, the first signaling is used to indicate a first time window, and time-domain resources occupied by any of the Q radio signals belong to the first time window.

In one subembodiment of the above embodiment, the first time window occupies more than one continuous slot.

In one subembodiment of the above embodiment, the first time window comprises Q slots, and the Q radio signals are respectively transmitted in the Q slots.

In one embodiment, the Q radio signals respectively occupy Q slots.

In one embodiment, the Q radio signals respectively occupy Q time units.

In one subembodiment of the embodiment, the Q time units are respectively Q sub-slots.

In one subembodiment of the embodiment, the Q time units are respectively Q mini-slots.

In one subembodiment of the above embodiment, any time unit in the Q time units occupies more than one multi-carrier symbol.

In one embodiment, the first signaling is used to indicate a first time window, and a duration of the first time window in time domain does not exceed P1 slots, where P1 is a positive integer greater than 1, and P1 is used to determine a value of P.

In one embodiment, P is equal to the M1.

In one embodiment, a maximum number of HARQ processes that can be supported by the first node is equal to K, and M1 is less than a difference value between K and K1.

In one embodiment, a maximum number of HARQ processes that can be supported by the first node is equal to K, and P is less than a difference value between K and K1.

In one embodiment, the Q data units are respectively Q bit blocks.

In one embodiment, the Q data units are respectively Q TBs.

In one embodiment, any two data units in the Q data units respectively correspond to two different bit blocks.

In one embodiment, any two data units in the Q data units respectively correspond to two different TBs.

In one embodiment, the Q data units are respectively and sequentially through Cyclic Redundancy Check (CRC) insertion, Low Density Parity Check Code (LDPC) base pattern selection, code block segmentation and code block CRC insertion, channel coding, rate matching, code-block connection, scrambling, modulation, layer mapping, multi-antenna precoding, and resource mapping to obtain the Q radio signals.

In one embodiment, the Q data units are respectively through at least one of CRC insertion, LDPC base pattern selection, code-block segmentation and code-block CRC insertion, channel coding, rate matching, code-block connection, scrambling, modulation, layer mapping, multi-antenna precoding, or resource mapping to obtain the Q radio signals

In one embodiment, the Q data units are respectively used to generate the Q radio signals.

In one embodiment, Q1 data unit(s) of the Q data units is(are) fed back a HARQ-ACK, and Q2 data unit(s) of the Q data units is(are) not fed back a HARQ-ACK, a sum of Q1 and Q2 being equal to Q, Q2 being a non-negative integer.

In one subembodiment of the above embodiment, the Q1 data unit(s) corresponds(respectively correspond) to Q1 process identity(identities) other than the K1 HARQ process identities.

In one subembodiment of the above embodiment, the Q2 data unit(s) corresponds(respectively correspond) to Q2 process identity(identities) among the K1 HARQ process identities, and Q2 is a positive integer not greater than K1.

In one embodiment, any data unit among the Q data units comprises at least one TB.

In one embodiment, any of the Q data units comprises at least one Code Block Group (CBG).

In one embodiment, any of the Q data units comprises at least one MAC Protocol Data Unit (PDU).

In one embodiment, the first resource set is a PUCCH resource.

In one embodiment, the first resource set is a PUCCH resource set.

In one embodiment, the target information block is a piece of Uplink Control Information (UCI).

In one embodiment, a physical-layer channel occupied by the target information block comprises a PUCCH.

In one embodiment, the first signaling is used to determine a slot occupied by the first resource set.

In one embodiment, the first signaling is used to determine frequency-domain resources occupied by the first resource set.

In one embodiment, any of the M1 bit group(s) comprises multiple bits.

In one embodiment, any of the M1 bit group(s) only comprises one bit.

In one embodiment, a value of M1 is independent of a value of Q indicated by the first signaling.

In one embodiment, a value of M1 is related to a maximum number of process identities other than the K1 HARQ process identities that can be indicated by the first signaling.

In one embodiment, a value of M1 is equal to a maximum number of process identities other than the K1 HARQ process identities that can be indicated by the first signaling.

In one embodiment, M1 is not greater than 16.

In one embodiment, M1 is not greater than 32.

In one embodiment, M1 is not greater than 64.

In one embodiment, the meaning of the phrase that any bit other than the Q1 bit group(s) among the M1 bit group(s) is reserved comprises: a value of any bit other than the Q1 bit group(s) among the M1 bit group(s) is unrelated to whether any data unit in the Q1 data unit(s) is correctly received.

In one embodiment, the meaning of the phrase that any bit other than the Q1 bit group(s) among the M1 bit group(s) is reserved comprises: a value of any bit other than the Q1 bit group(s) among the M1 bit group(s) is unrelated to whether any data unit in the Q data unit(s) is correctly received.

In one embodiment, the meaning of the phrase that any bit other than the Q1 bit group(s) among the M1 bit group(s) is reserved comprises: a value of any bit other than the Q1 bit group(s) among the M1 bit group(s) is fixed.

In one embodiment, the meaning of the phrase that any bit other than the Q1 bit group(s) among the M1 bit group(s) is reserved comprises: a value of any bit other than the Q1 bit group(s) among the M1 bit group(s) is equal to 0.

In one embodiment, the meaning of the phrase that any bit other than the Q1 bit group(s) among the M1 bit group(s) is reserved comprises: a value of any bit other than the Q1 bit group(s) among the M1 bit group(s) is equal to 1.

In one embodiment, the meaning of the phrase that any bit other than the Q1 bit group(s) among the M1 bit group(s) is reserved comprises: any bit other than the Q1 bit group(s) among the M1 bit group(s) is used to indicate a NACK.

In one embodiment, the meaning of the phrase that any bit other than the Q1 bit group(s) among the M1 bit group(s) is reserved comprises: any bit other than the Q1 bit group(s) among the M1 bit group(s) is not used to whether a data unit is correctly received.

In one embodiment, the meaning of the phrase that any bit other than the Q1 bit group(s) among the M1 bit group(s) is reserved comprises: a value of M1 is unrelated to a value of Q1.

In one embodiment, the meaning of the phrase that any bit other than the Q1 bit group(s) among the M1 bit group(s) is reserved comprises: a value of M1 is unrelated to a value of Q.

In one embodiment, the meaning of the phrase that any bit other than the Q1 bit group(s) among the M1 bit group(s) is reserved comprises: regardless of whether the first node receives the first signaling or not, the target information block comprises the M1 bit group(s).

In one embodiment, regardless of whether the first node receives the first signaling or not, the first node transmits the target information block in the first resource set.

In one embodiment, the first signaling comprises scheduling information of the Q radio signals, and the scheduling information comprises at least one of Modulation and Coding Scheme (MCS), Redundancy Version (RV), or New Data Indicator (NDI).

In one embodiment, P is related to a time interval between the first time-frequency resource pool and the first resource set

In one subembodiment of the embodiment, the larger the time interval between the first time-frequency resource pool and the first resource set, the larger the P.

In one embodiment, P is a number of time unit(s) between the first time-frequency resource pool and the first resource set.

In one embodiment, the time unit in the present application is slot.

In one embodiment, the time unit in the present application is sub-slot.

In one embodiment, the time unit in the present application is mini-slot.

In one embodiment, a duration of the time unit in the present application does not exceed 1 ms.

In one embodiment, any HARQ process identity among the Q1 HARQ process identity(identities) is a HARQ process identity other than the K1 HARQ process identities.

In one embodiment, any HARQ process identity among the Q HARQ process identity(identities) is a HARQ process identity other than the K1 HARQ process identities.

In one embodiment, a process identity in the present application is a non-negative integer.

In one embodiment, a process identity in the present application is less than the K.

In one embodiment, the monitoring comprises blind detection.

In one embodiment, the monitoring comprises detection.

In one embodiment, the monitoring comprises demodulation.

In one embodiment, the monitoring comprises reception.

In one embodiment, the monitoring comprises energy detection.

In one embodiment, the monitoring comprises coherent detection.

### Embodiment 2

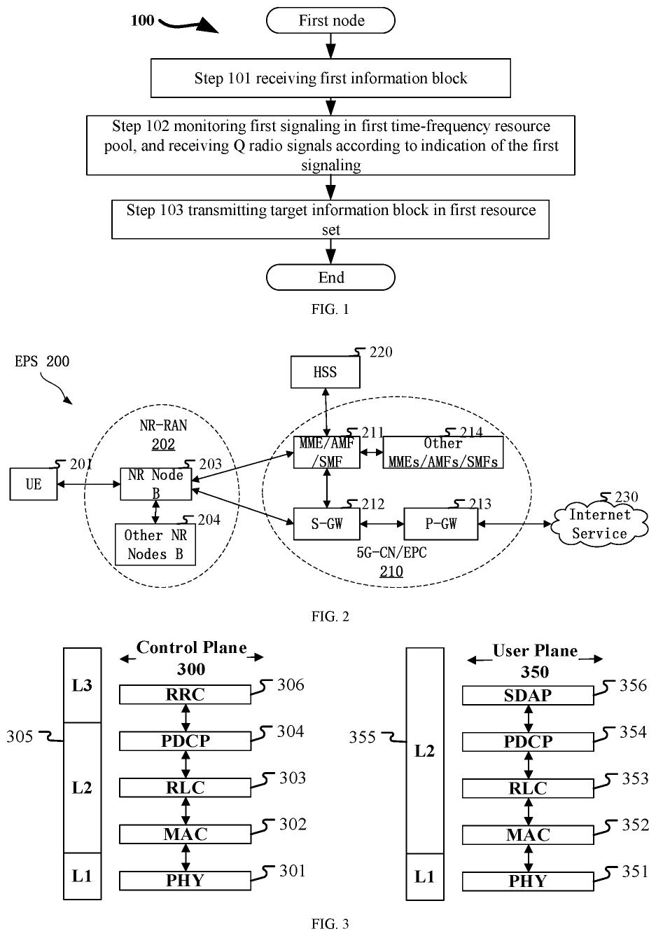

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMES/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a terminal that supports disabling partial HARQ process identities.

In one embodiment, the UE 201 is a terminal that supports NTN services.

In one embodiment, the UE 201 supports working on 52.6 GHz to 71 GHz frequency band.

In one embodiment, the UE 201 supports a DCI scheduling data transmissions of multiple different transmission blocks.

In one embodiment, the gNB 203 corresponds to the second node in the present application.

In one embodiment, the gNB 203 is a base station that supports disabling partial HARQ process identities.

In one embodiment, the gNB 203 is a base station that bears NTN services.

In one embodiment, the gNB 203 supports working on 52.6 GHz to 71 GHz frequency band.

In one embodiment, the gNB 203 supports a DCI scheduling data transmissions of multiple different transmission blocks.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first information block in the present application is generated by the PHY 301 or the PHY 351.

In one embodiment, the first information block in the present application is generated by the MAC 302 or the MAC 352.

In one embodiment, the first information block in the present application is generated by the RRC 306.

In one embodiment, the first signaling in the present application is generated by the PHY 301 or the PHY 351.

In one embodiment, the first signaling in the present application is generated by the MAC 302 or the MAC 352.

In one embodiment, any of the Q radio signals in the present application is generated by the MAC 302 or MAC 352.

In one embodiment, any of the Q radio signals in the present application is generated by the RRC 306.

In one embodiment, the target information block in the present application is generated by the PHY 301 or the PHY 351.

In one embodiment, the target information block in the present application is generated by the MAC 302 or the MAC 352.

In one embodiment, the target information block in the present application is generated by the RRC 306.

In one embodiment, the second information block in the present application is generated by the PHY 301 or the PHY 351.

In one embodiment, the second information block in the present application is generated by the MAC 302 or the MAC 352.

In one embodiment, the second information block in the present application is generated by the RRC 306.

In one embodiment, the third information block in the present application is generated by the PHY 301 or the PHY 351.

In one embodiment, the third information block in the present application is generated by the MAC 302 or the MAC 352.

In one embodiment, the third information block in the present application is generated by the RRC 306.

In one embodiment, the first node is a terminal.

In one embodiment, the second node is a terminal.

In one embodiment, the second node is a Road Side Unit (RSU).

In one embodiment, the second node is a Grouphead.

In one embodiment, the second node is a Transmitter Receiver Point (TRP).

In one embodiment, the second node is a cell.

In one embodiment, the second node is an eNB.

In one embodiment, the second node is a base station.

In one embodiment, the second node is used to manage multiple base stations.

In one embodiment, the second node is a node used for managing multiple cells.

In one embodiment, the second node is used to manage multiple TRPs.

In one embodiment, the second node is a non-terrestrial base station.

In one embodiment, the second node is one of Geostationary Earth Orbiting (GEO) satellite, Medium Earth Orbiting (MEO) satellite, Low Earth Orbit (LEO) satellite, Highly Elliptical Orbiting (HEO) satellite, or an Airborne Platform.

### Embodiment 4

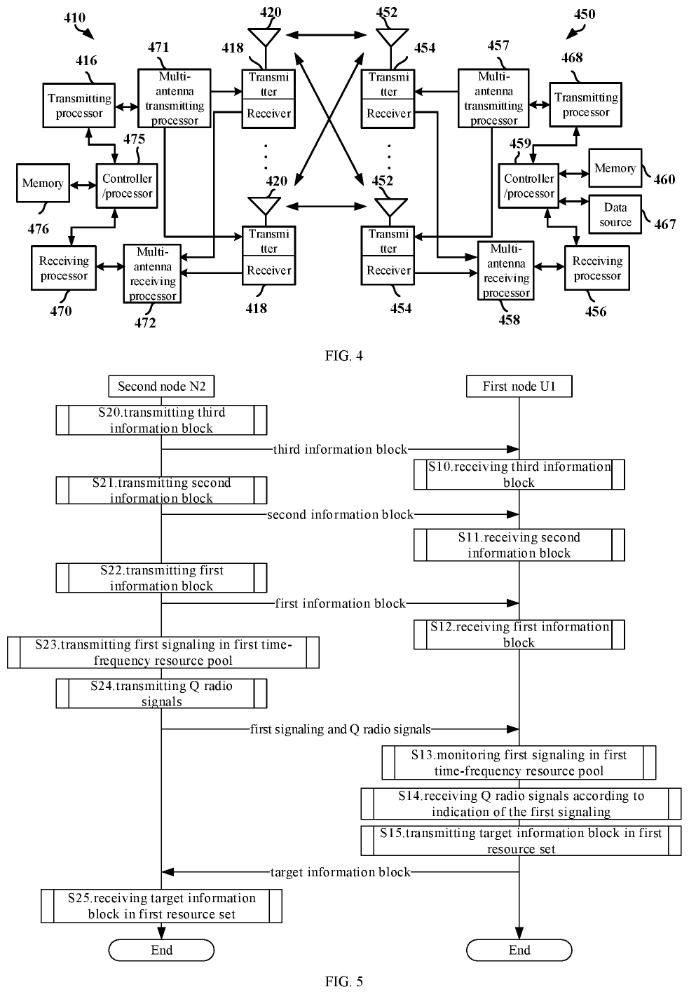

Embodiment 4 illustrates a schematic diagram of a first communication device and a second communication device in the present application, as shown in FIG. 4. FIG. 4 is a block diagram of a first communication device 450 being in communications with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor. The first communication device 450 at least: firstly receives a first information block, the first information block is used to disable HARQ-ACKs for K1 HARQ process identities, the K1 HARQ process identities are a subset of K HARQ process identities, K1 being a positive integer greater than 1 and K being a positive integer greater than K1; then monitors a first signaling in a first time-frequency resource pool, the first time-frequency resource pool belongs to a search space set; when the first signaling is detected, receives Q radio signals according to an indication of the first signaling, the Q radio signals respectively comprise Q data units; and transmits a target information block in a first resource set; the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

In one embodiment, the first communication device 450 comprises at least one processor and at least one memory. a memory that stores a computer readable instruction program. The computer readable instruction program generates an action when executed by at least one processor. The action includes: firstly receiving a first information block, the first information block being used to disable HARQ-ACKs for K1 HARQ process identities, the K1 HARQ process identities being a subset of K HARQ process identities, K1 being a positive integer greater than 1 and K being a positive integer greater than K1; then monitoring a first signaling in a first time-frequency resource pool, the first time-frequency resource pool belonging to a search space set; when the first signaling is detected, receiving Q radio signals according to an indication of the first signaling, the Q radio signals respectively comprising Q data units; and transmitting a target information block in a first resource set; the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: firstly transmits a first information block, the first information block is used to disable HARQ-ACKs for K1 HARQ process identities, the K1 HARQ process identities are a subset of K HARQ process identities, K1 being a positive integer greater than 1 and K being a positive integer greater than K1; then transmits a first signaling in a first time-frequency resource pool, the first time-frequency resource pool belongs to a search space set; the first signaling indicates a transmission of Q radio signals, the Q radio signals respectively comprise Q data units; and receives a target information block in a first resource set; the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

In one embodiment, the second communication device 410 comprises a memory that stores a computer readable instruction program. The computer readable instruction program generates an action when executed by at least one processor. The action includes: firstly transmitting a first information block, the first information block being used to disable HARQ-ACKs for K1 HARQ process identities, the K1 HARQ process identities being a subset of K HARQ process identities, K1 being a positive integer greater than 1 and K being a positive integer greater than K1; then transmitting a first signaling in a first time-frequency resource pool, the first time-frequency resource pool belonging to a search space set; the first signaling indicating a transmission of Q radio signals, the Q radio signals respectively comprising Q data units; and receiving a target information block in a first resource set; the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the second communication device 410 is a base station.

In one embodiment, the second communication device 410 is a UE.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first information block; at least first four of the antenna 420, the transmitter 418, the multi-antenna transmitting processor 471, the transmitting processor 416 and the controller/processor 475 are used to transmit a first information block.

In one embodiment, at least first four of the antenna 452, the receiver 454, the multi-antenna receiving processor 458, the receiving processor 456 and the controller/processor 459 are used to monitor a first signaling; at least first four of the antenna 420, the transmitter 418, the multi-antenna transmitting processor 471, the transmitting processor 416 and the controller/processor 475 are used to transmit a first signaling.

In one embodiment, at least first four of the antenna 452, the receiver 454, the multi-antenna receiving processor 458, the receiving processor 456 and the controller/processor 459 are used to receive Q radio signals according to an indication of the first signaling; at least first four of the antenna 420, the transmitter 418, the multi-antenna transmitting processor 471, the transmitting processor 416 and the controller/processor 475 are used to transmit Q radio signals.

In one embodiment, at least first four of the antenna 452, the receiver 454, the multi-antenna receiving processor 458, the receiving processor 456 and the controller/processor 459 are used to receive a second information block; at least first four of the antenna 420, the transmitter 418, the multi-antenna transmitting processor 471, the transmitting processor 416 and the controller/processor 475 are used to transmit a second information block.

In one embodiment, at least first four of the antenna 452, the receiver 454, the multi-antenna receiving processor 458, the receiving processor 456 and the controller/processor 459 are used to receive a third information block; at least first four of the antenna 420, the transmitter 418, the multi-antenna transmitting processor 471, the transmitting processor 416 and the controller/processor 475 are used to transmit a third information block.

### Embodiment 5

Embodiment 5 illustrates a flowchart of a first information block, as shown in FIG. 5. In FIG. 5, a first node U1 and a second node N2 are in communications through a radio link; it is particularly underlined that the order illustrated in the embodiment does not put constraints over sequences of signal transmissions and implementations.

The first node U1 receives a third information block in step S10; receives a second information block in step S11; receives a first information block in step S12; monitors a first signaling in a first time-frequency resource pool in step S13; receives Q radio signals according to an indication of the first signaling in step S14; transmits a target information block in a first resource set in step S15.

The second node N2 transmits a third information block in step S20; transmits a second information block in step S21; transmits a first information block in step S22; transmits a first signaling in a first time-frequency resource pool in step S23; transmits Q radio signals in step S24; receives a target information block in a first resource set in step S25.

In embodiment 5, the first information block is used to disable HARQ-ACKs for K1 HARQ process identities, the K1 HARQ process identities are a subset of K HARQ process identities, K1 being a positive integer greater than 1 and K being a positive integer greater than K1; the first time-frequency resource pool belongs to a search space set; the first signaling indicates the Q radio signals, and the Q radio signals respectively comprise Q data units; the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; P is a positive integer greater than 1; the second information block is used to determine a value of the P; the first resource set occupies a target time unit, the Q1 data unit(s) occupies(respectively occupy) Q1 time unit(s), and the third information block is used to determine that the target time unit is associated with the Q1 time unit(s).

In one embodiment, the first signaling comprises a first field, the first field in the first signaling is used to indicate a first time offset, and the first resource set occupies a target time unit; a last data unit in the Q1 data unit(s) occupies a first time unit; the first time unit and the first time offset are used together to determine the target time unit.

In one subembodiment of the embodiment, the first time offset is measured by slot.

In one subembodiment of the embodiment, the first time offset is measured by mini-slot.

In one subembodiment of the embodiment, the first time offset is measured by sub-slot.

In one subembodiment of the above embodiment, the first time offset is equal to T1, T1 being a non-negative integer.

In one subembodiment of the above embodiment, a slot occupied by the first time unit is slot T0, the first time offset value is equal to T1, a slot occupied by the target time unit is slot T2, and T2 is equal to a sum of T0 and T1; T0, T1, and T2 are all non-negative integers.

In one subembodiment of the embodiment, the first field in the first signaling is a PDSCH-TimedomainResourceAllocation field in a DCI.

In one subembodiment of the embodiment, the meaning of the phrase that a last data unit in the Q1 data unit(s) comprises: a latest data unit transmitted in time domain among the Q1 data unit(s).

In one subembodiment of the embodiment, the meaning of the phrase that a last data unit in the Q1 data unit(s) comprises: one data unit among the Q1 data unit(s) adopting a maximum HARQ process identity.

In one subembodiment of the embodiment, the target time unit is a slot.

In one subembodiment of the embodiment, the target time unit is a mini-slot.

In one subembodiment of the embodiment, the target time unit is a sub-slot.

In one subembodiment of the embodiment, the first time unit is a slot.

In one subembodiment of the embodiment, the first time unit is a mini-slot.

In one subembodiment of the embodiment, the first time unit is a sub-slot.

In one embodiment, the second information block is transmitted through an RRC signaling.

In one embodiment, the second information block is UE-specific.

In one embodiment, the second information block is transmitted through a MAC CE.

In one embodiment, the second information block is dynamically transmitted through a physical-layer signaling.

In one embodiment, the second information block is transmitted through a PDCCH.

In one embodiment, the second information block is used to indicate the P.

In one embodiment, the second information block is used to indicate a first time window, and a maximum number of HARQ process identities other than the K1 HARQ process identities that can be comprised by the first time window is equal to P.

In one subembodiment of the embodiment, the second information block indicates a duration of the first time window in time domain.

In one subembodiment of the embodiment, the second information block does not indicate a start time of the first time window in time domain.

In one subembodiment of the embodiment, a duration of time-domain resources jointly occupied by the Q data units in time domain is not greater than a duration of the first time window in time domain.

In one subembodiment of the embodiment, the first time window occupies Q3 continuous slots in time domain, and Q3 is a positive integer not less than Q.

In one subembodiment of the embodiment, the first time window occupies Q3 continuous mini-slots in time domain, and Q3 is a positive integer not less than Q.

In one subembodiment of the embodiment, the first time window occupies Q3 continuous sub-slots in time domain, and Q3 is a positive integer not less than Q.

In one embodiment, the second information block is used to indicate that a number of continuous slots indicated by the first signaling is equal to Q3, where Q3 is a positive integer greater than P, and an active HARQ process identity in the indicated Q3 continuous slots is equal to P.

In one embodiment, the third information block is transmitted through an RRC signaling.

In one embodiment, the third information block is UE-specific.

In one embodiment, the third information block is used to indicate that the target time unit is associated with the Q1 time unit(s).

In one embodiment, the third information block is used to indicate that the target time unit is associated with the Q time units.

In one embodiment, the third information block is a dl-Data-ToUL-ACK field in TS 38.331.

In one embodiment, the meaning of the above phrase that the target time unit is associated with the Q1 time unit(s) comprises: a HARQ feedback adopting a type 1 HARQ-ACK codebook for a data unit transmitted in the Q1 time unit is transmitted in the target time unit.

In one embodiment, the meaning of the above phrase that the target time unit is associated with the Q1 time unit(s) comprises: a PDSCH transmitted in the Q1 time unit(s) is comprised in a candidate PDSCH reception occasion set of a PUCCH transmitted in the target time unit.

In one embodiment, the Q1 bit group(s) is(are) first Q1 bit group(s) among the M1 bit group(s).

In one embodiment, the M1 bit group(s) are sequentially sorted in the target information block, and the M1 bit group(s) are sequentially indexed as bit groups #0 to bit groups #(M1−1), and the bit group #0 to bit group #(Q1−1) in the M1 bit group(s) are respectively the Q1 bit group(s).

In one embodiment, any of the M1 bit group(s) only comprises one bit, and the target information block comprises M1 bits, the M1 bits are sequentially sorted, and the first Q1 bits in the M1 bits are respectively the Q1 bit group(s).

In one embodiment, the Q1 bit group(s) is(are) last Q1 bit group(s) among the M1 bit group(s).

In one subembodiment of the embodiment, the M1 bit group(s) are sequentially sorted in the target information block, the M1 bit group(s) are sequentially indexed as bit groups #0 to bit groups #(M1−1), and bit group #(M1−Q1) to bit group #(M1−1) in the M1 bit group(s) are respectively the Q1 bit group(s). In one subembodiment of the embodiment, any of the M1 bit group(s) only comprises one bit, the target information block comprises M1 bit(s), the M1 bit(s) is(are) sequentially sorted, and the last Q1 bit(s) in the M1 bit(s) is(are) the Q1 bit group(s).

In one embodiment, the first signaling comprises a second field, the second field in the first signaling is used to indicate a first one of HARQ process identities among the Q HARQ process identities.

In one subembodiment of the embodiment, the second field in the first signaling is used to indicate the first one of of the Q HARQ process identities among the K HARQ process identities.

In one subembodiment of the embodiment, the second field in the first signaling is used to indicate the first one of the Q HARQ process identities other than the K1 process identities from the K HARQ process identities.

In one subembodiment of the embodiment, the meaning of the above phrase that the first one of the Q HARQ process identities comprises: a HARQ process identity with a smallest process identity among the Q HARQ process identities.

In one subembodiment of the embodiment, the meaning of the above phrase that the first one of the Q HARQ process identities comprises: a HARQ process identity occupying earliest time-domain resources among the Q HARQ process identities.

In one subembodiment of the embodiment, the meaning of the above phrase that the first one of the Q HARQ process identities comprises: a HARQ process identity corresponding to a data unit occupying earliest time-domain resources among Q data units respectively corresponding to the Q HARQ process identities.

In one embodiment, the target information block adopts a generation method of type 1 HARQ-ACK codebook.

In one subembodiment of the embodiment, a size of the type 1 HARQ-ACK codebook does not dynamically change with the actual data scheduling situation.

In one subembodiment of the embodiment, a size of the type 1 HARQ-ACK codebook does not change with an indication of a dynamic signaling of the physical layer.

### Embodiment 6

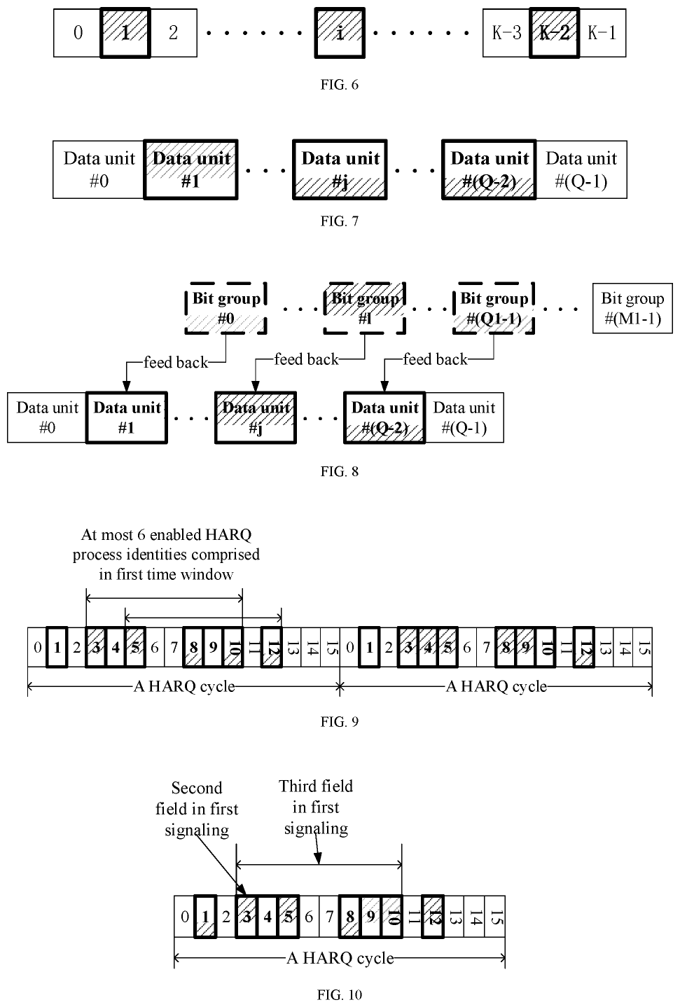

Embodiment 6 illustrates a schematic diagram of K1 process identities, as shown in FIG. 6. In FIG. 6, the first node at most supports K HARQ process identities, and among the K HARQ process identities, K1 HARQ process identities are used to disabled a HARQ-ACK. A box in the figure represents a HARQ process, and the sequence number in the box represents a HARQ process identity corresponding to the HARQ process, the i in the figure represents a HARQ process identity of the corresponding box, while bold slash-filled box represents a HARQ process identity of a disabled HARQ-ACK.

In one embodiment, a HARQ process identity of the disabled HARQ-ACK can be adopted as data transmission, but a receiving end of the data does not provide HARQ-ACK feedback for data transmitted on a HARQ process identity of the disabled HARQ-ACK.

In one embodiment, the process identities of the K HARQ processes are sequentially 0 to (K−1).

In one embodiment, the K1 HARQ process identities are continuous.

In one embodiment, there at least exist two of the K1 HARQ process identities being discontinuous.

### Embodiment 7

Embodiment 7 illustrates a schematic diagram of Q data units, as shown in FIG. 7. In FIG. 7, the Q data units are transmitted in Q time units respectively; the rectangle box in the figure represents Q time units, and data unit #0 to data unit #(Q−1) identified in the figure correspond to the Q data units; only Q1 data unit(s) in the Q data units is(are) fed back HARQ-ACK; the bold slash-filled box represents Q1 time unit(s) occupied by the Q1 data unit(s), and the Q1 time unit(s) is(are) a subset of the Q time units; a data unit #j in the figure is one of the Q1 data unit(s).

In one embodiment, the Q time units are continuous.

In one embodiment, the Q time units are Q non-uplink slots.

In one subembodiment of the embodiment, the Q non-uplink slots are discontinuous.

In one subembodiment of the above embodiment, the non-uplink slot comprises a downlink slot.

In one subembodiment of the above embodiment, the non-uplink slot comprises a flexible slot.

### Embodiment 8

Embodiment 8 illustrates a schematic diagram of M1 bit group(s), as shown in FIG. 8. In FIG. 8, Q1 bit group(s) in the M1 bit group(s) is(are respectively) used to indicate whether Q1 data unit(s) is(are) correctly received, and a bit group other than the Q1 bit group(s) among the M1 bit group(s) is reserved; the slash-filled rectangle(s) framed with dashed lines in the figure represents the Q1 bit group(s); the slash-filled rectangle(s) framed with thick and solid lines in the figure represents the Q1 data unit(s).

In one embodiment, any two of the M1 bit groups comprise a same number of bits.

In one embodiment, the first node is configured to support receiving W1 CBGs in one slot, and a number of bits comprised in any of the M1 bit group(s) is equal to W1.

In one embodiment, the first node is configured to support receiving W1 CBGs in one slot, and a number of bits comprised in any of the M1 bit group(s) is not less than W1.

### Embodiment 9

Embodiment 9 illustrates a schematic diagram of P HARQ process identities at most indicated by the first signaling, as shown in FIG. 9. In FIG. 9, the first node supports 16 HARQ processes, respectively corresponding to process identity #0 to process identity #15; a HARQ-ACK feedback of 8 process identities out of the 16 process identities is enabled, and the remaining 8 process identities are disabled; numbers in the boxes represent a corresponding HARQ process identity, and each box represents a time unit; two complete HARQ cycles are illustrated in the figure, each of which consists of 16 process identities, the enabled process identities are represented by slash-filled rectangles framed with thick and solid lines in the figure; from the figure, it can be seen that when the first signaling can schedule up to 8 time units, a maximum number of enabled HARQ process identities indicated by the first signaling is equal to 6.

In one embodiment, the 8 time units correspond to a first time window indicated by the second information block in the present application.

In one embodiment, the P is equal to 6.

### Embodiment 10

Embodiment 10 illustrates a schematic diagram of a first signaling, as shown in FIG. 10. In FIG. 10, the first signaling comprises a second field, the second field in the first signaling is used to indicate a first one of HARQ process identities among the Q HARQ process identities; the first signaling comprises a third field, and the third field is used to indicate Q. The first node illustrated in the figure supports 16 HARQ process identities, and numbers in the box represent corresponding HARQ process identities. The slash-filled rectangle framed with thick and solid lines in the figure represents an enabled process identity; the second field in the first signaling indicates process identity #3 among the 16 process identities, and the third field in the first signaling indicates Q being equal to 8; the process identity #3 to process identity #10 are used for transmitting data units, and from the process identity #3 to process identity #10, process identities in the slash-filled rectangle framed with thick and solid lines support HARQ-ACK feedback.

### Embodiment 11

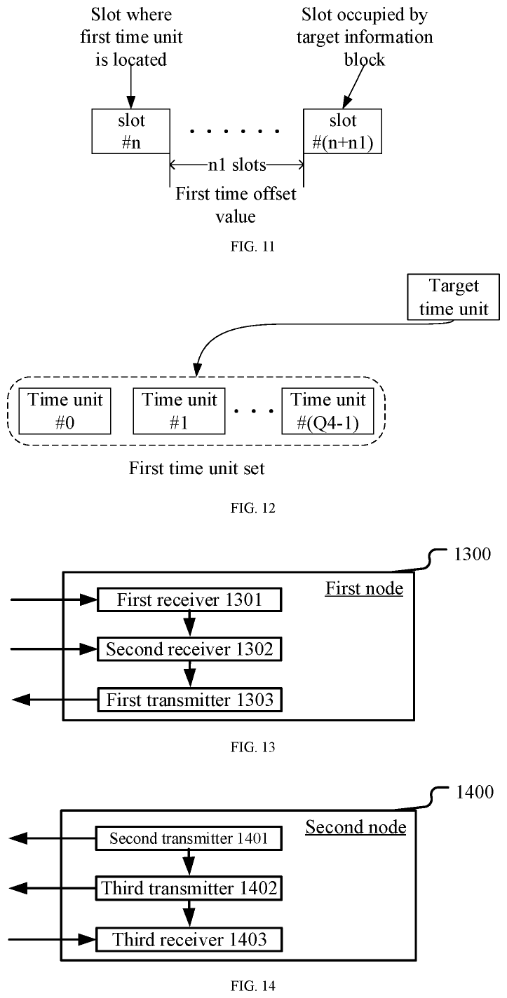

Embodiment 11 illustrates a schematic diagram of a first time unit and a first time offset value, as shown in FIG. 11. In FIG. 11, the first time unit is located in slot #n, the slot #n is a slot occupied by a data unit corresponding to a latest enabled HARQ process identity indicated by the first signaling, the first time offset value is equal to n1 slot(s), and a slot occupied by the target information block is equal to slot #(n+n1), n being a non-negative integer, n1 being a positive integer.

In one embodiment, the target information block is transmitted in a Physical Uplink Shared Channel (PUSCH).

In one embodiment, the target information block is transmitted in an Uplink Shared Channel (UL-SCH).

### Embodiment 12

Embodiment 12 illustrates a schematic diagram of a target time unit, as shown in FIG. 12. In FIG. 12, the target time unit is associated with a first time unit set, the first time unit set comprises Q4 time units; the Q4 is a positive integer greater than 1; time units in the dashed box in the figure correspond to Q4 time units comprised in the first time unit set; time unit #0 to time unit #(Q4-1) respectively correspond to the Q4 time units comprised in the first time unit set.

In one embodiment, any time unit of the Q1 time unit(s) in the present application is one of the Q4 time units comprised in the first time unit set.

In one embodiment, Q4 is less than the Q1.

In one embodiment, Q4 is less than the Q.

In one embodiment, any time unit of the Q time units in the present application is one of the Q4 time units comprised in the first time unit set.

In one embodiment, an RRC signaling is used to indicate that the target time unit is associated with the first time unit set.

In one embodiment, the Q4 time units are continuous in time domain.

In one embodiment, there at least exist two of the Q4 time units being discontinuous in time domain.

In one embodiment, Q4 is equal to K in the present application.

In one embodiment, Q4 is equal to P in the present application.

### Embodiment 13

Embodiment 13 illustrates a structure block diagram in a first node, as shown in FIG. 13. In FIG. 13, a first node 1300 comprises a first receiver 1301, a second receiver 1302 and a first transmitter 1303.

The first receiver 1301 receives a first information block, the first information block is used to disable HARQ-ACKs for K1 HARQ process identities, the K1 HARQ process identities are a subset of K HARQ process identities, K1 being a positive integer greater than 1 and K being a positive integer greater than K1;
the second receiver 1302 monitors a first signaling in a first time-frequency resource pool, the first time-frequency resource pool belongs to a search space set; when the first signaling is detected, receives Q radio signals according to an indication of the first signaling, the Q radio signals respectively comprise Q data units;
the first transmitter 1303 transmits a target information block in a first resource set;

In embodiment 13, the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

In one embodiment, the first signaling comprises a first field, the first field in the first signaling is used to indicate a first time offset, and the first resource set occupies a target time unit; a last data unit in the Q1 data unit(s) occupies a first time unit; the first time unit and the first time offset are used together to determine the target time unit.

In one embodiment, the first receiver 1301 receives a second information block; the second information block is used to determine a value of the P.

In one embodiment, the first receiver 1301 receives a third information block; the first resource set occupies a target time unit, the Q1 data unit(s) occupies(respectively occupy) Q1 time unit(s), and the third information block is used to determine that the target time unit is associated with the Q1 time unit(s).

In one embodiment, the Q1 bit group(s) is(are) first Q1 bit group(s) among the M1 bit group(s).

In one embodiment, the first signaling comprises a second field, the second field in the first signaling is used to indicate a first one of HARQ process identities among the Q HARQ process identities.

In one embodiment, the target information block adopts a generation method of type 1 HARQ-ACK codebook.

In one embodiment, the first receiver 1301 comprises at least first four of the antenna 452, the receiver 454, the multi-antenna receiving processor 458, the receiving processor 456 and the controller/processor 459 in embodiment 4.

In one embodiment, the second receiver 1302 comprises at least first four of the antenna 452, the receiver 454, the multi-antenna receiving processor 458, the receiving processor 456 and the controller/processor 459 in embodiment 4.

In one embodiment, the first transmitter 1303 comprises at least the first four of the antenna 452, the transmitter 454, the multi-antenna transmitting processor 457, the transmitting processor 468 and the controller/processor 459 in embodiment 4.

### Embodiment 14

Embodiment 14 illustrates a structure block diagram of in a second node, as shown in FIG. 14. In FIG. 14, a second node 1400 comprises a second transmitter 1401, a third transmitter 1402 and a third receiver 1403.

The second transmitter 1401 transmits a first information block, the first information block is used to disable HARQ-ACKs for K1 HARQ process identities, the K1 HARQ process identities are a subset of K HARQ process identities, K1 being a positive integer greater than 1 and K being a positive integer greater than K1;
the third transmitter 1402 transmits a first signaling in a first time-frequency resource pool, the first time-frequency resource pool belongs to a search space set; the first signaling indicates a transmission of Q radio signals, the Q radio signals respectively comprise Q data units;
the third receiver 1403 receives a target information block in a first resource set;

In embodiment 14, the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

In one embodiment, the first signaling comprises a first field, the first field in the first signaling is used to indicate a first time offset, and the first resource set occupies a target time unit; a last data unit in the Q1 data unit(s) occupies a first time unit; the first time unit and the first time offset are used together to determine the target time unit.

In one embodiment, the second transmitter 1401 also transmits a second information block; the second information block is used to determine a value of the P.

In one embodiment, the second transmitter 1401 transmits a third information block; the first resource set occupies a target time unit, the Q1 data unit(s) occupies(respectively occupy) Q1 time unit(s), and the third information block is used to determine that the target time unit is associated with the Q1 time unit(s).

In one embodiment, the Q1 bit group(s) is(are) first Q1 bit group(s) among the M1 bit group(s).

In one embodiment, the first signaling comprises a second field, the second field in the first signaling is used to indicate a first one of HARQ process identities among the Q HARQ process identities.

In one embodiment, the target information block adopts a generation method of type 1 HARQ-ACK codebook.

In one embodiment, the second transmitter 1401 comprises at least first five of the antenna 420, the transmitter 418, the multi-antenna transmitting processor 471, the transmitting processor 416 and the controller/processor 475 in embodiment 4.

In one embodiment, the third transmitter 1402 comprises at least first four of the antenna 420, the transmitter 418, the multi-antenna transmitting processor 471, the transmitting processor 416 and the controller/processor 475 in embodiment 4.

In one embodiment, the third receiver 1403 comprises at least the first six of the antenna 420, the receiver 418, the multi-antenna receiving processor 472, the receiving processor 470 and the controller/processor 475 in embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, cars, RSUs, aircrafts, diminutive airplanes, unmanned aerial vehicles, tele-controlled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first information block, the first information block being used to disable HARQ-ACKs for K1 HARQ process identities, the K1 HARQ process identities being a subset of K HARQ process identities, K1 being a positive integer greater than 1 and K being a positive integer greater than K1;
a second receiver, monitoring a first signaling in a first time-frequency resource pool, the first time-frequency resource pool belonging to a search space set; when the first signaling is detected, receiving Q radio signals according to an indication of the first signaling, the Q radio signals respectively comprising Q data units; and
a first transmitter, transmitting a target information block in a first resource set;
wherein the first signaling is used to indicate Q HARQ process identities, and HARQ process identities of the Q data units are respectively the Q HARQ process identities; the target information block comprises M1 bit group(s), Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

2. The first node according to claim 1, wherein the first signaling comprises a first field, the first field in the first signaling is used to indicate a first time offset, and the first resource set occupies a target time unit; a last data unit in the Q1 data unit(s) occupies a first time unit; the first time unit and the first time offset are used together to determine the target time unit.

3. The first node according to claim 1, wherein the first receiver receives a second information block; the second information block is used to determine a value of the P.

4. The first node according to claim 1, wherein the first receiver receives a third information block; the first resource set occupies a target time unit, the Q1 data unit(s) occupies(respectively occupy) Q1 time unit(s), and the third information block is used to determine that the target time unit is associated with the Q1 time unit(s).

5. The first node according to claim 1, wherein the Q1 bit group(s) is(are) first Q1 bit group(s) among the M1 bit group(s).

6. The first node according to claim 1, wherein the first signaling comprises a second field, the second field in the first signaling is used to indicate a first one of HARQ process identities among the Q HARQ process identities.

7. The first node according to claim 1, wherein the target information block adopts a generation method of type 1 HARQ-ACK codebook.

8. The first node according to claim 1, wherein, the meaning of the phrase of disabling HARQ-ACKs for K1 HARQ process identities comprises one of the following:
the first node does not provide feedback on a corresponding HARQ-ACK for any of the K1 HARQ process identities;
a given data unit adopts one of the K1 HARQ process identities, and the first node does not provide feedback on a corresponding HARQ-ACK based on whether the given data unit is correctly received after receiving the given data unit;
a given data unit adopts one of the K1 HARQ process identities, the first node does not provide feedback on HARQ-ACK after receiving the given data unit, regardless of whether the given data unit is correctly received;
a given data unit adopts one of the K1 HARQ process identities, the first node provides feedback on NACK after receiving the given data unit, regardless of whether the given data unit is correctly received;
a given data unit adopts one of the K1 HARQ process identities, the first node provides feedback on ACK after receiving the given data unit, regardless of whether the given data unit is correctly received;
the first node assumes that there exist no Physical Uplink Control Channel (PUCCH) resource reserved for transmitting a feedback for any of the K1 HARQ process identities.

9. The first node according to claim 1, wherein the meaning of the above phrase that any bit other than the Q1 bit group(s) among the M1 bit group(s) is reserved comprises at least one of the following:
a value of any bit other than the Q1 bit group(s) in the M1 bit group(s) is unrelated to whether any data unit in the Q1 data unit(s) is correctly received;
a value of any bit other than the Q1 bit group(s) in the M1 bit group(s) is unrelated to whether any data unit in the Q data units is correctly received;
a value of any bit other than the Q1 bit group(s) in the M1 bit group(s) is fixed;
a value of any bit other than the Q1 bit group(s) in the M1 bit group(s) is equal to 0;
a value of any bit other than the Q1 bit group(s) in the M1 bit group(s) is equal to 1;
any bit other than the Q1 bit group(s) in the M1 bit group(s) is used to indicate NACK;
any bit other than the Q1 bit group(s) in the M1 bit group(s) is not used to whether a data unit is correctly received;
a value of M1 is unrelated to a value of Q1;
a value of M1 is unrelated to a value of Q;
regardless of whether the first node receives the first signaling or not, the target information block comprises the M1 bit group(s).

10. The first node according to claim 1, wherein regardless of whether the first node receives the first signaling or not, the first node transmits the target information block in the first resource set.

11. A second node for wireless communications, comprising:
a second transmitter, transmitting a first information block, the first information block being used to disable HARQ-ACKs for K1 HARQ process identities, the K1 HARQ process identities being a subset of K HARQ process identities, K1 being a positive integer greater than 1 and K being a positive integer greater than K1;
a third transmitter, transmitting a first signaling in a first time-frequency resource pool, the first time-frequency resource pool belonging to a search space set; the first signaling indicating a transmission of Q radio signals, the Q radio signals respectively comprising Q data units; and
a third receiver, receiving a target information block in a first resource set;
wherein the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.

12. The second node according to claim 11, wherein the first signaling comprises a first field, the first field in the first signaling is used to indicate a first time offset, and the first resource set occupies a target time unit; a last data unit in the Q1 data unit(s) occupies a first time unit; the first time unit and the first time offset are used together to determine the target time unit.

13. The second node according to claim 11, wherein the second transmitter transmits a second information block; the second information block is used to determine a value of the P.

14. The second node according to claim 11, wherein the second transmitter transmits a third information block; the first resource set occupies a target time unit, the Q1 data unit(s) occupies(respectively occupy) Q1 time unit(s), and the third information block is used to determine that the target time unit is associated with the Q1 time unit(s).

15. The second node according to claim 11, wherein the Q1 bit group(s) is(are) first Q1 bit group(s) among the M1 bit group(s).

16. The second node according to claim 11, wherein the first signaling comprises a second field, the second field in the first signaling is used to indicate a first one of HARQ process identities among the Q HARQ process identities.

17. The second node according to claim 11, wherein the target information block adopts a generation method of type 1 HARQ-ACK codebook.

18. The second node according to claim 1, wherein the meaning of the phrase of disabling HARQ-ACKs for K1 HARQ process identities comprises one of the following:
the first node does not provide feedback on a corresponding HARQ-ACK for any of the K1 HARQ process identities;
a given data unit adopts one of the K1 HARQ process identities, and the first node does not provide feedback on a corresponding HARQ-ACK based on whether the given data unit is correctly received after receiving the given data unit;
a given data unit adopts one of the K1 HARQ process identities, the first node does not provide feedback on HARQ-ACK after receiving the given data unit, regardless of whether the given data unit is correctly received;
a given data unit adopts one of the K1 HARQ process identities, the first node does not provide feedback on HARQ-ACK after receiving the given data unit, regardless of whether the given data unit is correctly received;
a given data unit adopts one of the K1 HARQ process identities, the first node does not provide feedback on HARQ-ACK after receiving the given data unit, regardless of whether the given data unit is correctly received;
the first node assumes that there exist no PUCCH resource reserved for transmitting a feedback for any of the K1 HARQ process identities.

19. The second node according to claim 11, wherein the meaning of the above phrase that any bit other than the Q1 bit group(s) among the M1 bit group(s) is reserved comprises at least one of the following:
a value of any bit other than the Q1 bit group(s) in the M1 bit group(s) is unrelated to whether any data unit in the Q1 data unit(s) is correctly received;
a value of any bit other than the Q1 bit group(s) in the M1 bit group(s) is unrelated to whether any data unit in the Q data unit(s) is correctly received;
a value of any bit other than the Q1 bit group(s) in the M1 bit group(s) is fixed;
a value of any bit other than the Q1 bit group(s) in the M1 bit group(s) is equal to 0;
a value of any bit other than the Q1 bit group(s) in the M1 bit group(s) is equal to 1;
any bit other than the Q1 bit group(s) in the M1 bit group(s) is used to indicate NACK;
any bit other than the Q1 bit group(s) in the M1 bit group(s) is not used to whether a data unit is correctly received;
a value of M1 is unrelated to a value of Q1;
a value of M1 is unrelated to a value of Q;
regardless of whether the first node receives the first signaling or not, the target information block comprises the M1 bit group(s).

20. A method in a first node for wireless communications, comprising:
receiving a first information block, the first information block being used to disable HARQ-ACKs for K1 HARQ process identities, the K1 HARQ process identities being a subset of K HARQ process identities, K1 being a positive integer greater than 1 and K being a positive integer greater than K1;
monitoring a first signaling in a first time-frequency resource pool, the first time-frequency resource pool belonging to a search space set; when the first signaling is detected, receiving Q radio signals according to an indication of the first signaling, the Q radio signals respectively comprising Q data units; and
transmitting a target information block in a first resource set;
wherein the first signaling is used to indicate Q HARQ process identities, and HARQ process identities of the Q data units are respectively the Q HARQ process identities; the target information block comprises M1 bit group(s), and Q1 bit group(s) in the M1 bit group(s) is(are respectively) used to indicate whether Q1 data unit(s) is(are) correctly received, and any bit group in the M1 bit group(s) comprises at least one bit; the Q1 data unit(s) consists(consist) of data unit(s) whose corresponding HARQ process identity(identities) is(are) other than the K1 HARQ process identities among the Q data units; Q1 is a non-negative integer, and M1 is a positive integer not less than the Q1; any bit other than the Q1 bit group(s) in the M1 bit group(s) is reserved, and the first signaling at most indicate P HARQ process identities other than the K1 HARQ process identities, M1 being related to the P; the P is a positive integer greater than 1.
